(19) United States
(12) Patent Application Publication
(10) Pub. No.: US 2003/0220845 A1
(43) Pub. Date: Nov. 27, 2003

(54) System and method for processing online purchase

(75) Inventors: Te-Mei Chu, Taipei (TW); Shu-Mei Chien, Taipei (TW); Yun-Chi Lee, Taipei (TW); Kuan-I Wu, Taipei (TW)

Correspondence Address: THE LAW OFFICES OF MIKIO ISHIMARU, 1110 SUNNYVALE-SARATOGA ROAD, SUITE A1, SUNNYVALE, CA, 94087, US

(73) Assignee: INVENTEC CORPORATION, Taipei (TW)

(21) Appl. No.: 10/379,777

(22) Filed: Mar. 4, 2003

(30) Foreign Application Priority Data
May 23, 2002 (TW) 91110851

(51) Int. Cl. G06F 17/60

(52) U.S. Cl. 705/26

(57) ABSTRACT

A system and a method for processing online purchase are provided, wherein purchase processing stations of a buyer and a seller are respectively linked to the purchase processing system via a network. A user database is established in the purchase processing system for storing user data and identification codes corresponding to the user data, and an order database is provided for storing order data. The purchase processing system verifies access rights of a user according to an identification code input by the user, and obtains order data from the order database requested by the user, allowing the obtained order data to be displayed on a purchase processing station of the user. Then, the purchase processing system processes orders according to the user's instruction, wherein the processed orders are marked with specific labels and stored in the order database.

### FIELD OF THE INVENTION

The present invention relates to systems and methods for processing online purchase, and more particularly, to a system and method for processing online purchase by which a current status of order processing is readily accessible to a buyer and a seller.

### BACKGROUND OF THE INVENTION

In conventional trade activities, buyers often convey their purchase requests via processing methods, such as telephone and fax during the purchase operation, while the sellers also adopt the above-mentioned processing method to reply the processing status requested by the buyer.

However, if the purchase operation is executed by telephone and fax, the time and labor involved in processing transmission between the buyer and seller are increased, especially when any party would like to change or modify the purchase operation. For example, both the buyer and seller need to submit modification request and reply, respectively as the buyer increase/decrease order amount or modify the order product items. And the same situation applies when the seller's stock is unable to meet the buyer's purchase demand.

With flourishing development in network technology, many life-dependent mechanisms can be carried out online. For example, Electronic Commerce (EC) that involves commercial activity performed via a variety of network technologies has become a definite developing trend for both the buyer and seller. And trade data, such as order, invoice, and other electronic documents, are transmitted among industries with business relation using Electronic Data Interchange (EDI) technology. Therefore, the cost for document transmission and message exchange among the industries is effectively reduced via Electronic Commerce.

Even though the labor and time cost involved in transmitting message between the buyer and seller can be reduced via the EDI technology, and the communication can be made more frequent to effectively eliminate order error and unnecessary conflict between the buyer and seller, the buyer and seller can not instantly control and fully understand related data after document transmission. For example, after the buyer sends one or more purchase electronic forms via Internet to the web server of the seller simultaneously or at different time, the buyer is not aware of a status of processing the purchase orders that were sent out except through the reply from the seller after the purchase orders are received. Therefore, the buyer often has to wait passively for the reply from the seller, without knowing data such as unreplied purchase order, purchase order replied by the seller, delivery date, allowable delivery amount, and so on. Otherwise, the buyer has to request the seller to actively obtain the status of processing the purchase operation via E-mail, telephone, and fax.

Since the purchase processing system available does not provide the buyer and seller with any processing data after the purchase order is sent and received within the same purchase operation system, the modified order may not be responded instantly to another party when either party of the buyer and seller modifies the purchase order that was sent out or replied. As the buyer may not be able to keep track of the material stock of the seller instantly, a delay in production is resulted due to the shortage of the materials. Alternatively, the material supply may either exceed the demand or run short if the seller is unable to keep track of the buyer's purchasing actions instantly.

Therefore, to solve the above-mentioned problems in the system for processing the purchase operations from the buyer and seller, the purchase data from both parties need to be integrated to respond demands from both parties instantly, so that the buyer can keep track of the processing status of the purchase order received by the seller, and the seller can keep track of the purchasing actions of the buyer.

### SUMMARY OF THE INVENTION

To improve from the drawback associated with the conventional art, an objective of the present invention is to provide a system and method for processing online purchase, whereby the purchase processing messages between the buyer and seller are integrated to respond and reply the purchase demands between the buyer and seller as well as the operation status of the purchase order.

Another objective of the present invention is to provide a system and method for processing online purchase, so that the modification can be informed to another party without involving too much human resource when the buyer and seller change the purchase processing message.

As embodied and broadly described herein, the invention provides a system for processing the online purchase. The system of processing online purchase comprises an order database for storing a buyer order; a user database for storing a plurality of user data, wherein each of the user data corresponds to an identification code; a identity verification module for commanding the user to input the identification code when the user logs in the system of processing online purchase, so that an user authority is retrieved from the user database based on the identification code; an order searching module for the buyer and seller to input search parameters, so that orders that match the search parameters are searched from the order database according to the user authority after the identity verification module identifies the user authority, and the searched orders are displayed in the purchase processing station of the user; and an order replying module for the seller to input a reply request in the order when the order searching module locates unreplied orders, and the replied order is labeled with a replied mark and stored in the order database, so that the unreplied orders currently available are searched by the buyer and seller who log in the system of processing the online purchase.

The invention provides a method of processing online purchase, whereby a purchase processing station from either the buyer or seller is linked via a network system to a purchase processing system. The purchase processing system is established with a user database which stores a plurality of user data with each user data corresponds to an identification code, and a order database which stores the order from the buyer, so that the purchase process executed either by the buyer or seller is controlled through limiting authority of the user who logs in the purchase processing system. The method comprises at least steps of retrieving user authority from the user database according to the identification code input by the user, searching orders that match search items input by the user from the order database according to the search items and user authority, and displaying the searched orders in the purchase processing station of the user; the order processing system receiving the order process operation to be executed by the user; and labeling a specific processing mark on the order and storing the order in the order database according to a specific order processing operation executed if the user chooses to execute the order processing operation.

By comparison to the conventional art, the system and method for processing the online purchase saves the purchase order sent out by the buyer and allows the buyer and seller to execute processing, such as search, modification, and reply instantly. And unlike the conventional purchase processing operation that provides only uni-directional processing operations for both the buyer and seller, wasting more human resource and time, the buyer and the seller can control the operation status of the purchase order accurately and instantly by using the system and method for processing the online purchase according to the present invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram illustrating basic system architecture of the system for processing the online purchase according to the present invention;

FIGS. 2A to 2E are schematic diagrams illustrating online purchase order search with the purchase processing stations of the buyer and seller using the system and method of processing the online purchase according to one preferred embodiment;

FIG. 3 is a schematic diagram for a web page operation, so as to illustrate an example of online purchase order modification with the purchase processing stations of the buyer and seller using the system and method of processing the online purchase according to one preferred embodiment; and

FIG. 4 is a flow chart illustrating steps executed by the order processing system using the system and method of processing the online purchase according to one preferred embodiment.

### DETAILED DESCRIPTION OF THE PREFERRED EMBODIMENTS

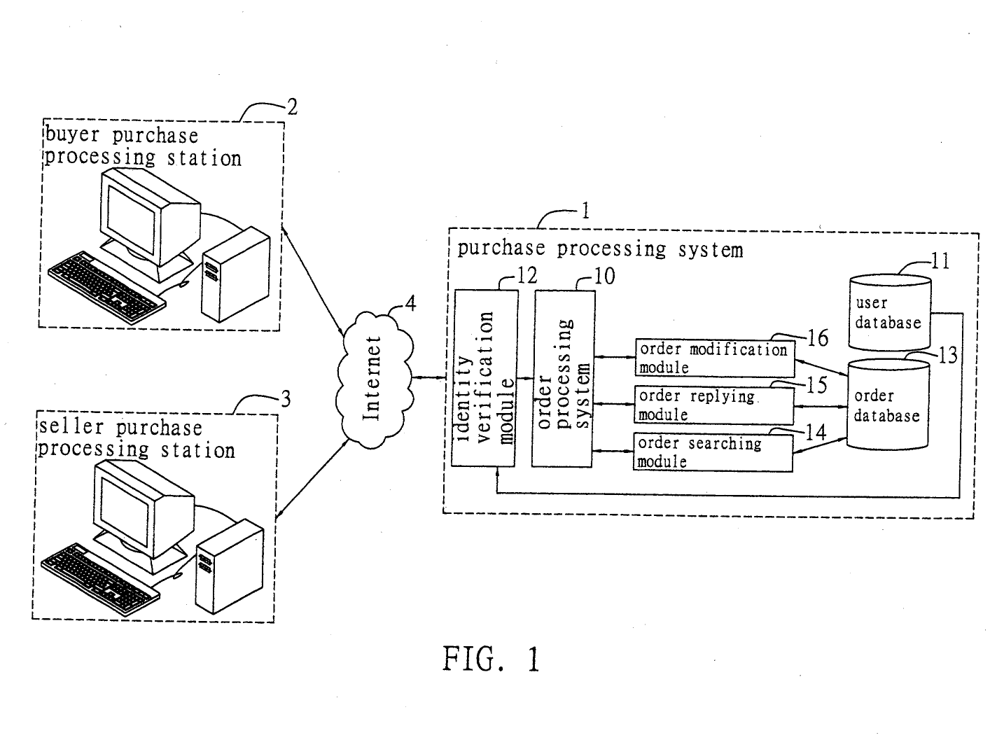

FIG. 1 is a block diagram illustrating basic system architecture of the system for processing online purchase according to one preferred embodiment of the present invention. As shown in FIG. 1, the system for processing online purchase includes at least a purchase processing system 1, a buyer purchase processing station 2 and a seller purchase processing station 3, and each of the purchase processing stations 2 and 3 is linked via a network system 4, such as Internet to the purchase processing system 1. The purchase processing stations 2 and 3, for example computer systems, include Internet browsing programs, such as Microsoft Internet Explorer or Netscape Navigator. The purchase processing system 1 serves to provide the buyer and seller at the purchase processing stations 2 and 3 with purchase processing programs, and can be constructed in a network server (not shown). The purchase processing system 1 includes an order processing module 10, a user database 11, an identity verification module 12, an order database 13, an order searching module 14, an order replying module 15, and an order modification module 16.

The order processing module 10 is used to receive requests from the purchase processing stations 2 and 3 of the buyer and seller, such as requests for searching, replying and modifying orders, and process the requests (detailed hereinafter) with the processed data being transmitted via the network system 4 to the purchase processing stations that submit the requests. The processed data are then displayed using the Internet browser programs installed in the purchase processing stations 2 and 3.

The user database 11 stores a plurality of user data, while each user data corresponds to an identification code. The identification code allows identity verification of the user who logs in the purchase processing system 1, so as to limit authority of the log in user. The identification code may comprise log in account and log in password of the user, while the user in this case may include purchase personnel responsible for processing purchase matters on either the buyer or the seller side, and system manager or program designer responsible for maintaining a variety of operations of the purchase processing system 1.

The identity verification module 12 prompts the user to input an identification code when the user logs in the purchase processing system 1, so that a user authority is retrieved from the user database 11 according to the identification code. Since the buyer and seller have different user authorities, the purchase processing system 1 transmits different processed data to the purchase processing stations 2 and 3 respectively for displaying according to the identification code of the user. For instance, the buyer can only browse the exclusive purchase order, whereas the seller can browse purchase orders sent from different buyers. And besides the users (purchase personnel) from both buyer and seller sides, the system maintaining personnel and system managing personnel are also permitted to log in the purchase processing system 1 for browsing and executing specific process in order to carry out data maintenance and system surveillance.

The order database 13 stores the purchase order sent from the buyer, wherein the order database 13 may be linked via a Intranet to a backstage main such as EDI platform (not shown) or Enterprise Resource Planning (ERP) system, so as to receive the online purchase order from the buyer.

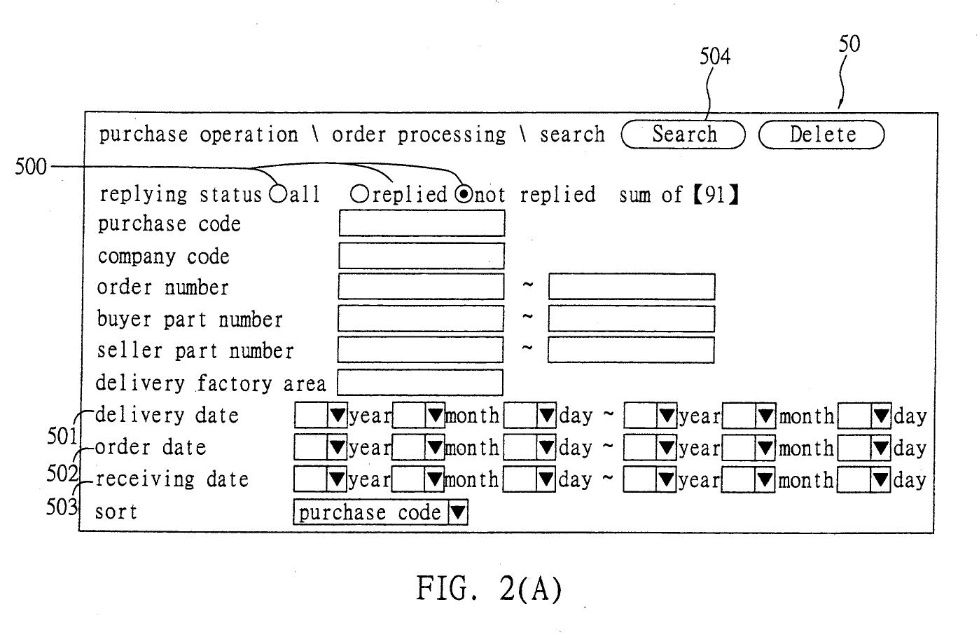

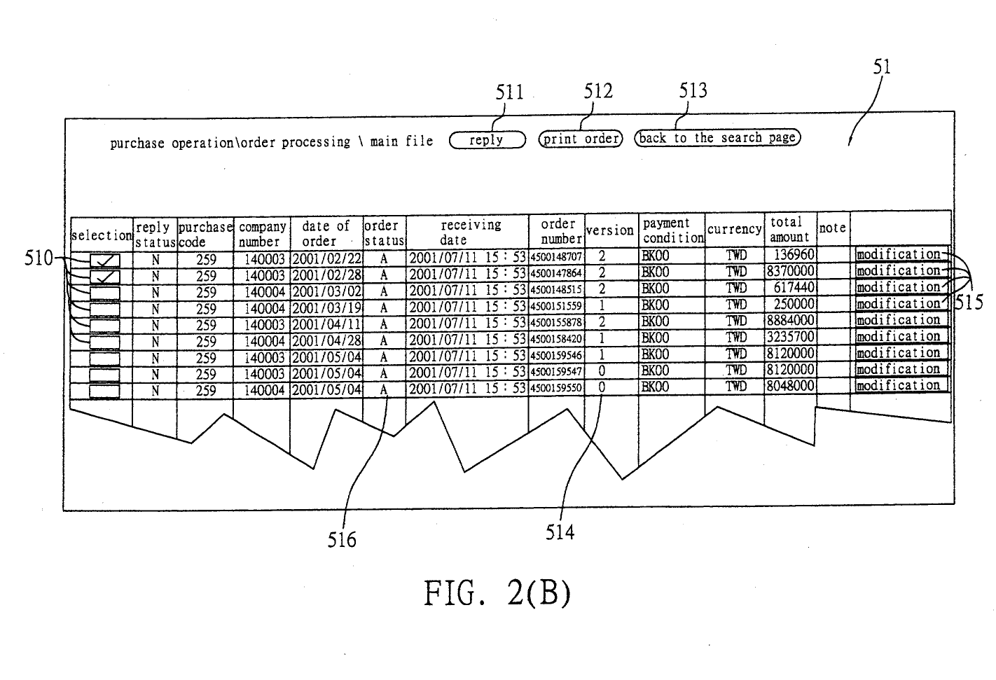

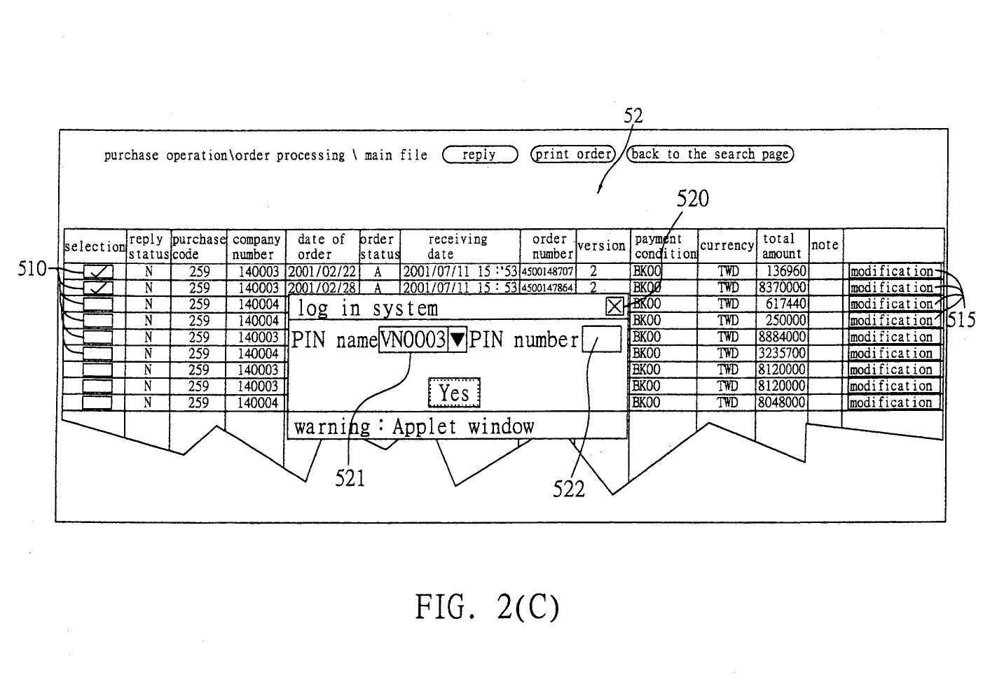

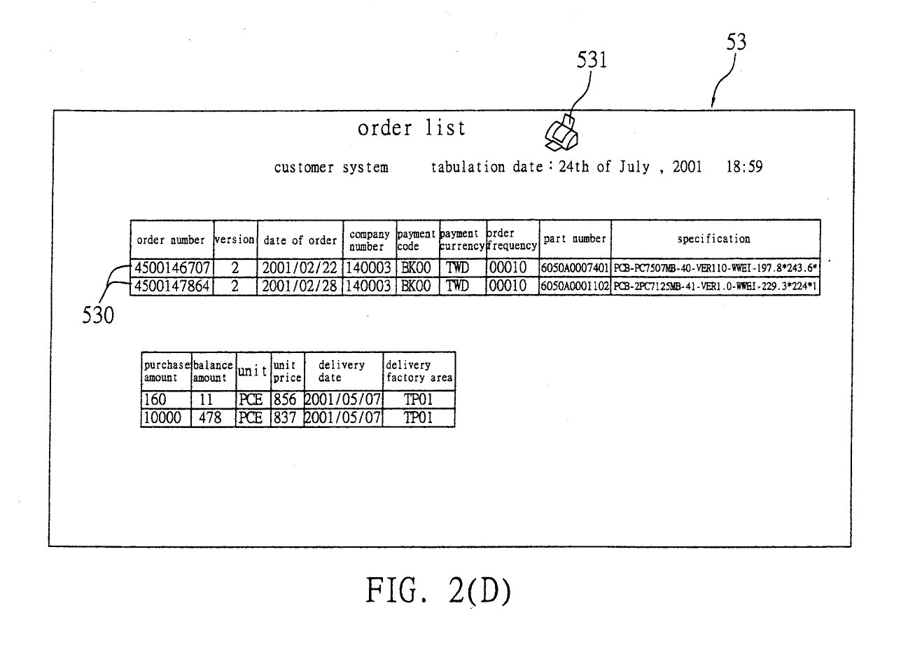

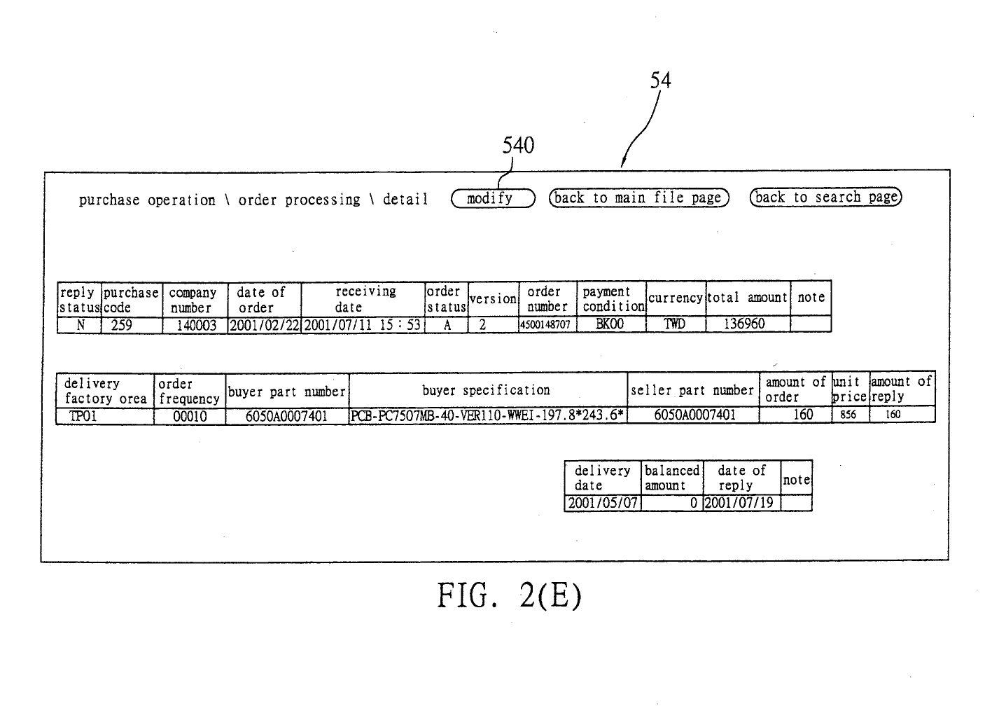

The order searching module 14 commands the identity verification module 12 to execute identity verification after the order processing module 10 receives the log-in request from users (including the buyer and seller) who wish to log in the purchase processing system 1. After the identity is verified, the order searching module 14 provides a searching form (shown in FIG. 2A) for the user to input searching parameters, and locates the purchase orders that match the searching parameters and the user authorities from the order database 13 before displaying the purchase orders.

With the order replying module 15 a reply request may be input on a display form of the purchase order unreplied to the user when the seller locates the purchase order unreplied to the buyer using the order searching module 14. And after the reply request is input, the order is labeled with a replied mark and stored in the order database, so that the buyer who logs in the purchase processing system 1 can search the purchase order not yet replied by the seller instantly.

With the order modification module 16, the buyer and seller can modify contents of the purchase orders located and displayed by the order searching module 14 after the buyer and seller search the required purchase order using the order searching module 14. And after the buyer and seller execute modification, the orders are labeled with a modification mark by the order modification module 16, while the modified order is stored in the order database 13.

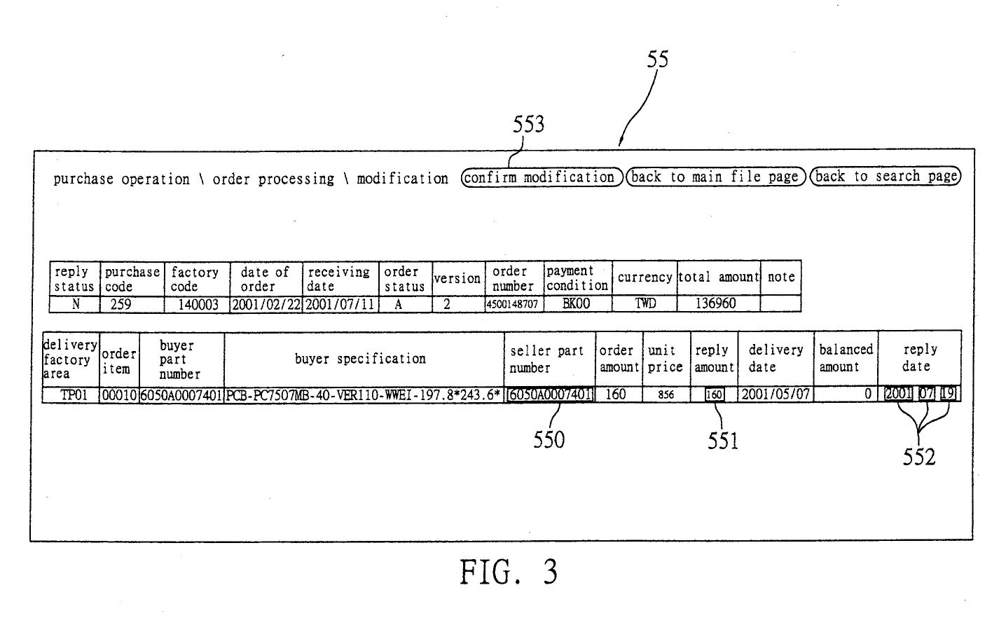

Referring to FIGS. 2A through 2E and FIG. 3 for illustrating examples of the online processing of purchase order using the system and method of processing online purchase order according to preferred embodiments of the present invention.

First of all, reference is made with FIGS. 2A through 2E to illustrate an online search of purchase orders carried out by the buyer and seller purchase processing stations 2 and 3. A shown in FIG. 2A, a web page 50 is perceived after the buyer and seller purchase processing stations 2 and 3 log in the purchase processing system 1, while the purchase processing system 1 calculates and displays a total count for the unreplied purchase orders. For example, 91 unreplied purchase orders are displayed on the web page 50. The following examples are described with the purchase processing system 1 operated by the seller. The user may select an option, such as “unreplied” option to be searched from the selection input menu 500 that corresponds to the reply status message row in the web page 50. And searching parameters, such as purchase code, manufacturer code, order number, buyer part number, and seller part number, and delivery factory area may be input. The “order delivery date” message row 501 in the web page 50 indicates the delivery date of the component to the purchased, while the “order placement date” message row 502 indicates the date for the backstage main (such as ERP system) to receive the purchase order, and the “receiving date” message row 503 indicates the date for the purchase processing system 1 to receive the purchase order. After the user has finished inputting and selects the “searching” command row 504, the purchase processing system 1 locates the purchase orders that match the parameters input by the user in the order database 13. So, when the user is the seller, he/she can browse the purchase orders from all buyers. But if the user is the buyer, he/she is only allowed to browse the purchase order sent out by the buyer.

Next, the purchase orders located by the purchase processing system 1 according to the searching parameters are displayed in the web page 51 as illustrated in FIG. 2B. The user may click on an input box 510 listed in the “select” message column of the web page 51 for the required order. And after the “reply” command row 511 is clicked, a dialogue box 520 appears in the web page 52 to prompt the user to input the identity data including the personal identity name and personal identity password in the “personal identity name” input box 520 and “personal identity password” input box 521, respectively. As a result, the purchase processing system 1 determines from the user database 11 whether the identity data matches the user authorized to reply according to the identity data input by the user. If the identity data matches the user, the “reply status” column of the selected order is labeled with a Y mark, and the labeled order is stored in the order database 13. However if the identity data does not match the user, the clicked order is not further processed. Therefore, purchase processing system 1 can determine if the order is replied according to the labeled mark in the “reply status” column of the order record. Generally, the user authorized to execute reply process is the purchase personnel from the seller side.

On the other hand, if the user clicks the required order in the input column 510 listed in the “select” message column of the web page 51 as illustrated in FIG. 2B and clicks the “print order list” command row 512, a web page 53 as illustrated in FIG. 2D is displayed, wherein the web page 53 displays the detailed data 530 of the clicked order. Then, if the user determines the detailed data is correct, the printer initiating command icon 531 is clicked to start printing.

Also, if the user clicks on the “back to searching page” command row 513 of the web page 51 as illustrated in FIG. 2B, a web page 50 as previously illustrated in FIG. 2A is displayed for the user to input the required searching parameters again.

Furthermore, if the user clicks on any order displayed in the web page 51 as illustrated in FIG. 2B, a web page 54 as illustrated in FIG. 2E is displayed for displaying the detailed data of the clicked order.

Next, referring to FIG. 3 for illustrating example of modifying purchase order online by the purchase processing stations 2 and 3 of the buyer and seller. The description is also made with reference to both FIGS. 2B and 2E. When the user clicks on the “modify” command row 515 of the web page 51 or the “modify” command row 540 of the web page 54, a web page 55 as illustrated in FIG. 3 is displayed. Since the present embodiment is described with the purchase processing system 1 operated by the seller, there are only “seller part number” input box 550, “reply amount” input box 551, and “reply date” input box for the user to input in the detailed data of the modified order displayed in the web page 55. After the user finishes inputting and clicks on the “confirmed modification” command row 553, the purchase processing system 1 stores the order data modified by the user in the order database 13. And if the order is modified for the first time, the “version” column 514 (i.e. the web page 51 as illustrated in FIG. 2B) of the modified order is changed from 0 to 1. As the order is modified for the second time, the “version” column 514 of the modified order is changed from 1 to 2, while the subsequent modification is recorded accordingly.

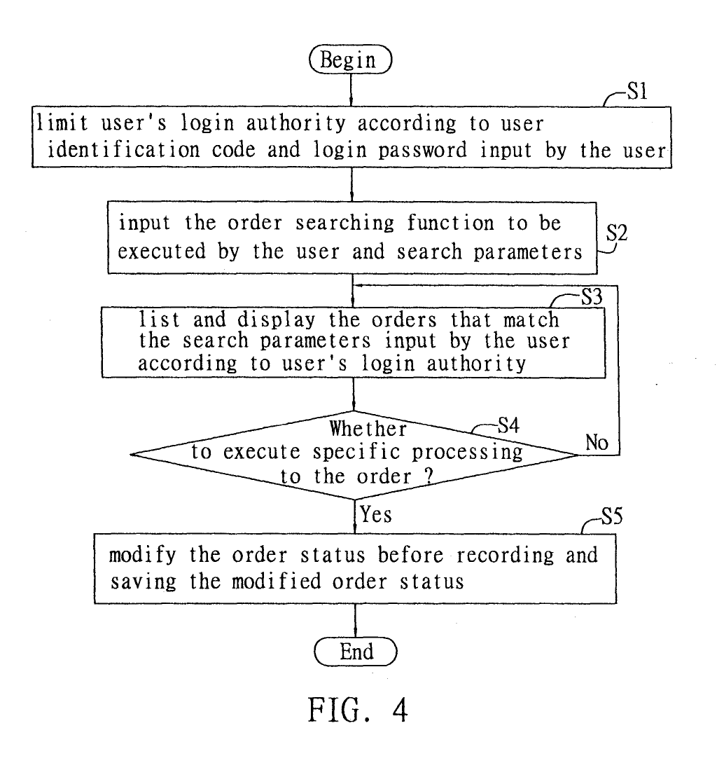

FIG. 4 is a flow chart for illustrating steps for executing the order processing system using the system and method of processing online purchase according to one preferred embodiment of the present invention. First of all, in step S1, the user is subjected to identity verification procedure before logging in the purchase processing system 1. For example, the user is prompted to input the user identity code and log in password, so that the identity verification module 12 can limit the user's authority to log in based on the user identity code and log in password input by the user.

Then, the process moves on to step S2. After the identity of the user is verified and the user authority is retrieved, the user can log in the purchase processing system 1 and input the required order searching function or searching parameters in the web page 50 as illustrated in FIG. 2A.

Next, the process moves on to step S3. According to the user's authority to log in and the order searching function input by the user, the purchase processing system 1 locates from the order database 13 for the orders that match the user's authority and searching parameters. And the orders are listed and displayed in the web page 51 as shown in FIG., 2B. So, if the user is the seller, he/she can browse the purchase orders from all buyers. But if the user is the buyer, he/she is only allowed to browse the purchase order sent out by the user.

The process moves on to step S4. The user can input the order processing functions, such as to reply, modify, and print purchase order using the web page 51 as illustrated in FIG. 2B. The purchase processing system 1 then determines whether the user executes the specific processes, such as reply, modification or other processes for the located and printed orders. When the user chooses to execute, the process moves on to step S5, whereby the purchase processing system 1 label the order with a specific processing mark according to the processing operation executed by the user. For example, if the user executes reply, the purchase order is labeled with a “Y” mark, and if the user executes modification, the purchase order is labeled with the modification number mark. Then the processed order is stored in the order database 13, such that the processing status of the order are controlled any time by the buyer and seller who log in the purchase processing system 1. Otherwise, if the purchase processing system 1 determines the user not to execute any specific processing operations in the step S4, the process then moves back to step S3.

Also, when the backstage main (such as ERP system) receives a request for adding a new order, an order record is established in the order database 13 by the purchase processing system 1 according to the newly added order. And the “order status” column 516 is labeled with a mark “A” illustrated as the web page 51 in FIG. 2B. However, when the backstage main receives a request for deleting the order that was sent out, the purchase processing system 1 locates the order record from the order database 13 according to the number of the deleted order. Then, the “order status” column 516 previously labeled with a mark “A” is modified as a mark “D”, indicating that the order has been modified. Therefore, the status of processing purchase order is managed and understood instantly without wasting too much labor and time using the system and method of processing online purchase according to the present invention.

The invention has been described using exemplary preferred embodiments. However, it is to be understood that the scope of the invention is not limited to the disclosed embodiments. For example, the labeling marks in the “reply status”, “order status”, and “version” columns of the web page 51 illustrated in FIG. 2B may be substituted with other labeling marks. On the contrary, it is intended to cover various modifications and similar arrangements. The scope of the claims, therefore, should be accorded the broadest interpretation so as to encompass all such modifications and similar arrangements.

What is claimed is:

1. A method for processing online purchase, for linking purchase processing stations of a buyer and a seller via a network system to a purchase processing system having a user database for storing user data and identification codes corresponding to the user data, and having an order database for storing orders from the buyer, allowing the purchase processing system to process orders in accordance with access rights of users, the method comprising steps of:
reading access rights of a user, who logs in the purchase processing system, from the user database according to an identification code input by the user, and obtaining orders from the order database according to search criteria input by the user and the user's access rights, allowing the obtained orders to be displayed in a purchase processing station of the user;
receiving via the purchase processing system instructions to process at least one of the orders from the user; and
processing via the purchase processing system the order according to the user's instructions and labeling a specific mark on the processed order, allowing the processed order to be stored in the order database.

2. The method of claim 1, wherein the purchase processing system is constructed in at least one network server.

3. The method of claim 1, wherein the order database is linked to a back-end host computer for receiving the orders from the buyer.

4. The method of claim 3, wherein the back-end host computer is an Enterprise Resource Planning (ERP) platform

5. The method of claim 1, wherein the order processing involves a reply or modification process.

6. A system for processing online purchase, for allowing purchase processing stations of a buyer and a seller to obtain purchase processing data via a network system, the system comprising:
an order database for storing orders from the buyer;
a user database for storing user data and identification codes corresponding to the user data;
an identity verification module for reading access rights of a user, who logs in the system for processing online purchase, from the user database according to an identification code input by the user;
an order search module for obtaining orders from the order database according to search criteria input by the user and the user's access rights, allowing the obtained orders to be displayed in a purchase processing station of the user; and
an order reply module for replying unreplied orders obtained by the order search module and labeling reply marks on the orders which are to be stored in the order database, thereby making unreplied orders readily accessible to the buyer and seller logging in the system for processing online purchase.

7. The system of claim 6, further comprising an order modification module for the buyer and seller to modify content of the orders obtained by the order search module, wherein the modified orders are labeled with modification marks and stored in the order database.

8. The system of claim 6, wherein the system for processing online purchase is constructed in at least one network server.

9. The system of claim 6, wherein the order database is linked to a back-end host computer for receiving the orders from the buyer.

10. The system of claim 9, wherein the back-end host computer is an Enterprise Resource Planning (ERP) platform.
